(19) United States
(12) Patent Application Publication
(10) Pub. No.: US 2023/0024328 A1
(43) Pub. Date: Jan. 26, 2023

(54) Method for Operating an Automated Motor Vehicle

(71) Applicant: Robert Bosch GmbH, Stuttgart (DE)

(72) Inventors: Christoph Gustav Keller, Stuttgart (DE); Holger Mielenz, Ostfildern (DE)

(21) Appl. No.: 17/814,061

(22) Filed: Jul. 21, 2022

(30) Foreign Application Priority Data
Jul. 22, 2021 (DE) 10 2021 207 831.1
Jan. 25, 2022 (DE) 10 2022 200 783.2

(51) Int. Cl. B60W 60/00; B60W 50/14

(52) U.S. Cl. CPC B60W 60/0013; B60W 50/14; B60W 2520/105; B60W 2050/143; B60W 2050/146; B60W 2556/45; B60W 2710/30

(57) ABSTRACT

A method for operating an automated motor vehicle during automated driving includes determining the current motor vehicle route data, a current trajectory of the motor vehicle, and environment information. The method also includes ascertaining a driving maneuver that is to be expected, associating this driving maneuver with one of the at least two motoring comfort levels, and outputting advice to the occupants of the motor vehicle if the current motoring comfort level changes as a result. The method further includes automatically and actively taking measures relating to the interior to adjust the interior to suit the motoring comfort level that is to be expected.

This application claims priority under 35 U.S.C. § 119 to (i) patent application no. DE 10 2021 207 831.1, filed on Jul. 22, 2021, and (ii) patent application no. DE 10 2022 200 783.2, filed on Jan. 25, 2022 in Germany. The disclosures of the above-identified patent applications are both incorporated herein by reference in their entirety.

The disclosure relates to a method for operating an automated motor vehicle during automated driving. In addition, the disclosure relates to a system for carrying out the method.

### BACKGROUND

Automatically driving vehicles permit their passengers to concentrate on other activities during journeys, meaning that the occupants are able to use the time gained for a gain in their personal comfort (reading, working, entertaining themselves, playing games, and so on). A common feature of such secondary activities is that passengers no longer concentrate on driving and suddenly-occurring changes in the acceleration/deceleration or transverse guidance of an ego vehicle are experienced without preparation. In certain cases, these changes may lead to a state of personal insecurity for the occupants (fright, reduced confidence, and so on). It is also conceivable that objects will be flung from the surface on which they are standing (cup falls from table, and so on) or muscular impairments may arise (neck muscle tears, and so on).

US 2020/0369294 A1 discloses an autonomous vehicle that comprises sensor units in order to detect vehicles in the surroundings. The vehicle ascertains whether a driving mode of the vehicle in the surroundings is an autonomous driving mode and whether there is an autonomous driving risk for the ego vehicle based on a trajectory error between the actual and expected trajectories of the vehicle in the surroundings. Based on this, a warning is output to a passenger. The warning may have different warning levels.

The object on which the disclosure is based is to specify a method that is used to increase the safety of the occupants of an automated motor vehicle during automated driving.

The object is achieved by a method for operating an automated motor vehicle during automated driving having the features disclosed herein. Additionally, the disclosure specifies a system for carrying out the method.

### SUMMARY

The disclosure specifies a method for operating an automated motor vehicle during automated driving. The method according to the disclosure comprises the steps of determining the current motor vehicle route data, a current trajectory of the motor vehicle and environment information, ascertaining a driving maneuver that is to be expected, associating this driving maneuver with one of the at least two motoring comfort levels, outputting advice to the occupants of the motor vehicle if the current motoring comfort level changes as a result, and automatically and actively taking measures relating to the interior to adjust the interior to suit the motoring comfort level that is to be expected.

Automated driving is understood to mean autonomous driving at the automation level of SAE level 4 or 5. This means that no driver interventions are necessary as a rule. This allows the occupants to play or work, for example. The motor vehicle route data comprise the destination or an intermediate destination, and also the driving route to the destination. Every turning operation, for example, or leaving or changing of a freeway is therefore known. Such operations may influence the current driving state. A trajectory describes the previously planned route on the freeway. The trajectory is also dependent on the traffic present on the road, or freeway.

The environment information comprises information relating to a motor vehicle environment. It is ascertained by means of lidar, radar, ultrasound or optical camera, for example. As a result, other vehicles, obstacles, road signs, etc., are captured. The environment of the motor vehicle therefore likewise influences the current driving. The driving maneuver is therefore an operation that changes the current driving state, for example in order to turn off, leave the freeway, change lane, stay in lane, slow down, or avoid another vehicle. The available data may be taken as a basis for anticipating such a driving maneuver at an early stage, i.e. before the driving maneuver is performed.

The motoring comfort level for the purposes of this disclosure indicates to the occupants an extent of the permitted activities and freedoms in the motor vehicle. Accordingly, motoring comfort for the occupants increases. As motoring comfort increases, it may be assumed that there is no change in driving maneuvers in a foreseeable period. For the comfort levels, a distinction may be drawn for example between a comfortable journey, in the case of which it may be assumed that no objects can slide from trays, and a dynamic journey. Advice in good time before a change of motoring comfort level allows motoring comfort for the occupants to be increased, because they are permitted more comfort. Similarly, the safety of the occupants may be increased if they receive advice at an early stage before a change to a lower motoring comfort level. The confidence of the occupants in automated driving is additionally increased.

Since, during a comfortable journey, the interior is used by the occupants accordingly, trays may be open, seats adjusted or an entertainment system in operation, for example. During a dynamic journey, the safety of the occupants may be endangered by for example objects flying around, etc. Measures relating to the interior concern operations that are necessary in order to put the interior into a state that is defined for the motoring comfort level. This state may be predefined or changed by the occupants within certain limits. The necessary measures relating to the interior are advantageously detected by way of sensors. Taking measures relating to the interior thus ensures the safety of the occupants. Since the measures relating to the interior are taken automatically and actively, a necessary measure that could endanger the safety of the occupants is prevented from being forgotten. It is also not necessary for these measures to be taken by the occupants, which increases motoring comfort.

In one preferred embodiment of the disclosure, the association of the driving maneuver with a motoring comfort level comprises the steps of ascertaining the acceleration values that are to be expected, comparing these acceleration values with threshold values for the motoring comfort levels, and determining the motoring comfort level. The acceleration values comprise values relating to acceleration/deceleration in the direction of travel and transversely with respect to the direction of travel. The threshold values are values beyond which a motoring comfort level is changed. However, a higher motoring comfort level is achieved with lower acceleration values in this case. Since the accelerations are the cause of the safety of the occupants, this allows the safety of the occupants to be increased.

In a further preferred embodiment of the disclosure, the threshold values for the acceleration values for the motoring comfort levels are set by the occupants. The occupants may set acceleration values beyond which an acceleration is found to be disturbing for the applicable motoring comfort level. Since the acceleration values are perceived differently in the occupants, this allows comfort for the occupants to be individually adjusted and therefore increased.

Preferably, the association of the driving maneuver with a motoring comfort level comprises the steps of comparing the driving maneuver that is to be expected with a predetermined driving maneuver association, and determining the motoring comfort level on the basis of the driving maneuver association if a motoring comfort level has been determined for this driving maneuver. The driving maneuver association is a list of possible driving maneuvers in which driving maneuvers have an associated motoring comfort level. Such a driving maneuver association simplifies the association for the applicable driving maneuver.

In one advantageous development, the driving maneuver association of the different driving maneuvers is created by the occupants. The occupants may accordingly associate a motoring comfort level with different driving maneuvers. This allows the association to be adjusted to suit the needs of the occupants, which means that the comfort of the occupants is increased.

Advantageously, the advice that is output is a visual or audible signal for the occupants. Such a signal advises the occupants of a change of motoring comfort level at an early stage. The safety and comfort of the occupants is increased as a result, since they are advised of the change of motoring comfort level at an early stage. Preferably, the type of advice may also be set individually by the occupants.

In a further advantageous embodiment, the advice of a change of motoring comfort level is output a predetermined time before the event that is to be expected. In this case, the time is proportioned such that the occupants are able to adjust to the changes, in particular in the event of a decrease in the motoring comfort level. Advantageously, the predetermined time is in the range between 5-30 s. This means that the occupants have enough time to prepare themselves for the new motoring comfort level, so that for example objects flying around may be cleared away in good time. Safety and motoring comfort for the occupants may be increased as a result.

Preferably, the occupants are prompted to take the measures relating to the interior by the advice. The occupants may thus take the measures relating to the interior within a certain time themselves before this is carried out automatically. By way of example, this allows the occupants to recline their seats themselves before this is carried out automatically. Motoring comfort for the occupants is additionally increased as a result.

In one advantageous development, the measures relating to the interior are trays closed, head-up display activated, steering device provided, interior lighting adjusted, seat position adjusted and/or entertainment system stopped. This allows a multiplicity of measures relating to the interior to be taken in order to increase the safety of the occupants. Taking these measures also prepares the occupants for a change in the motoring comfort situation, which means that the occupants do not get a fright in subsequent dynamic driving situations. Motoring comfort is increased as a result.

The disclosure is additionally achieved by a system for carrying out the method. The system comprises a scheduling unit that can be used to plan a motor vehicle route and a trajectory, an environment sensor system that can be used to ascertain environment information relating to the motor vehicle environment, a processing unit that can be used to determine a driving maneuver that is to be expected and the associated motoring comfort level, an output unit, for outputting advice about a change of motoring comfort level to the occupants, and means for automatically and actively taking measures relating to the interior. The scheduling unit is a device that takes the current position and the desired destination position as a basis for planning the route and the trajectory of the vehicle. It is thus also planned when the motor vehicle needs to turn off or to exit the freeway, for example.

The processing unit processes the information from the scheduling unit and the environment sensor system so that an applicable driving maneuver is anticipated and a motoring comfort level is determinable therefor. The output unit may be any device that can be used to communicate advice to the occupants visually or audibly. Such a system is used to achieve the advantages cited for the method.

According to one expedient embodiment, the processing unit is configured to ascertain the acceleration values that are to be expected. When selecting the motoring comfort level, the acceleration that is to be expected may thus additionally be taken into consideration. The motoring comfort level may thus be determined more accurately. The comfort and safety of the occupants is increased as a result.

According to a further expedient embodiment, the scheduling unit and/or the processing unit is arranged in a cloud. This has the advantage that the processing power in the motor vehicle may be reduced. The processing power is arranged at a central location as a result. The increased processing power in the cloud also allows the processing speed to be increased, which means that the time before the change of motoring comfort level, in particular in the case of driving maneuvers caused by the environment sensor system, may be increased.

The disclosure is additionally achieved by a motor vehicle that has such a system. Such a motor vehicle achieves the advantages cited above.

The method described above may be in particular computer-implemented, for example, and thus embodied in software. The disclosure therefore also relates to a computer program having machine-readable instructions that, when executed on one or more computers, cause the computer(s) to carry out the method described. With this in mind, control units for vehicles and embedded systems for technical devices that are likewise capable of executing machine-readable instructions may also be regarded as computers.

Similarly, the disclosure also relates to a machine-readable data carrier and/or to a download product having the computer program. A download product is a digital product that is transferrable via a data network, i.e. downloadable by a user of the data network, and that may be offered for sale in an online shop, for example, for immediate download.

Furthermore, a computer may be equipped with the computer program, with the machine-readable data carrier or with the download product.

### BRIEF DESCRIPTION OF THE DRAWINGS

Exemplary embodiments of the disclosure are shown in the drawing and are explained more thoroughly in the description that follows. In the drawing:

FIG. 1 shows a first exemplary embodiment of a method according to the disclosure, and

FIG. 2 shows a second exemplary embodiment of the method according to the disclosure.

### DETAILED DESCRIPTION

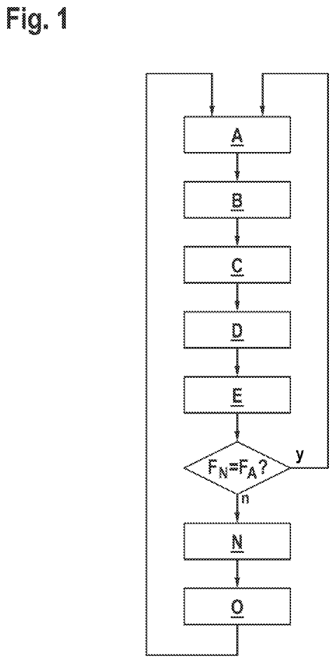

FIG. 1 shows a first exemplary embodiment of a method according to the disclosure. This method relates in particular to a method during automated driving of the automated motor vehicle. In a first method step A, the motor vehicle route data, a current trajectory and environment information of the motor vehicle are determined. On the basis of these data, a driving maneuver that is to be expected is ascertained in a next step B. This driving maneuver is determined by way of a processing unit of the motor vehicle.

In a subsequent step C, the processing unit is used to ascertain the acceleration values, such as for example longitudinal acceleration or transverse acceleration, that are to be expected as a result of the driving maneuver. The ascertained acceleration values are compared with threshold values for the motoring comfort levels in a subsequent step D. These threshold values may have been preset at the factory, or have been set by the occupants. In step E, a motoring comfort level is assigned for the driving maneuver. The motoring comfort level may indicate whether the driving maneuver involves a comfortable journey, in the case of which no objects slide from trays, or a dynamic journey, in the case of which objects may fall from trays.

After that, a check is performed to ascertain whether the new motoring comfort level F_{N} corresponds to the current motoring comfort level F_{A}. If this is the case, the method is started over. Should the new motoring comfort level F_{N} be higher or lower than the current driving level F_{A}, visual or audible advice that the motoring comfort level is changing is provided to the occupants in the next step N by way of an output unit. The advice is output a predetermined time before the actual driving maneuver so that the occupants have enough time to prepare themselves for the driving maneuver. The advice may additionally prompt the occupants to take necessary measures relating to the interior. In a subsequent step O, measures relating to the interior are automatically taken to take the measures relating to the interior that have not been taken by the occupants and to adjust the interior to suit the motoring comfort level that is to be expected.

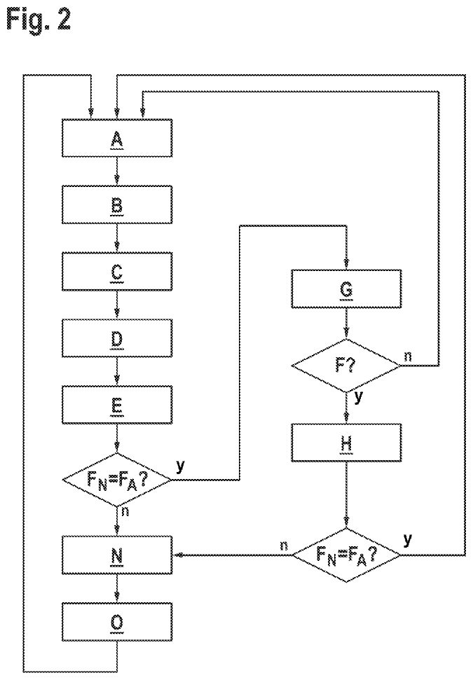

FIG. 2 shows a second exemplary embodiment of the method according to the disclosure. The method of the second exemplary embodiment differs from the method from FIG. 1 in that after it has been established that the motoring comfort level has not changed, a next step involves the driving maneuver being compared with a driving maneuver association. In this driving maneuver association, different driving maneuvers may be associated with a specific motoring comfort level. As a result, for example driving maneuvers that are regarded as uncritical based on the acceleration values may nevertheless be associated with a different category on the basis of personal feelings of the occupants. This increases the comfort of the occupants.

Following the comparison, a check is performed to ascertain whether a motoring comfort level has been stored for this driving maneuver. If no motoring comfort level has been stored, the method starts over. Otherwise, step H involves the motoring comfort level F_{N} being assigned a new value. A check is accordingly performed to ascertain whether the new motoring comfort level F_{N} corresponds to the current motoring comfort level F_{A}. Should the two values be identical, the method is started over. Otherwise, step N involves advice being output to the occupants regarding the changed motoring comfort level F_{N}. After that, step O involves automatically taking measures relating to the interior to adjust the interior to suit the motoring comfort level that is to be expected.

What is claimed is:

1. A method for operating an automated motor vehicle during automated driving, comprising:
determining current motor vehicle route data of the automated motor vehicle, a current trajectory of the automated motor vehicle, and environment information relating to a motor vehicle environment of the automated motor vehicle;
ascertaining a driving maneuver of the automated motor vehicle that is to be expected;
associating the ascertained driving maneuver with a determined motoring comfort level selected from at least two motoring comfort levels;
outputting advice to occupants of the automated motor vehicle when a current motoring comfort level changes as a result; and
automatically and actively taking measures relating to an interior of the automated motor vehicle to adjust the interior to suit the determined motoring comfort level.

2. The method according to claim 1, wherein the association of the ascertained driving maneuver with the determined motoring comfort level comprises:
ascertaining acceleration values of the automated motor vehicle that are to be expected;
comparing the ascertained acceleration values with threshold acceleration values for the at least two motoring comfort levels; and
selecting the determined motoring comfort level based on the comparison.

3. The method according to claim 2, further comprising:
setting the threshold acceleration values by the occupants.

4. The method according to claim 1, wherein the association of the ascertained driving maneuver with the determined motoring comfort level comprises:
comparing the ascertained driving maneuver that is to be expected with a predetermined driving maneuver association; and
selecting the determined motoring comfort level based on the predetermined driving maneuver association when a corresponding motoring comfort level has been determined for the predetermined driving maneuver.

5. The method according to claim 4, further comprising:
creating the predetermined driving maneuver association by the occupants for a plurality of driving maneuvers.

6. The method according to claim 1, wherein the advice that is output is a visual or audible signal for the occupants.

7. The method according to claim 1, wherein the outputting the advice comprises:
outputting notice of a change of the motoring comfort level a predetermined time before an event that is to be expected.

8. The method according to claim 1, wherein the outputting the advice comprises:
prompting the occupants to take the measures relating to the interior.

9. The method according to claim 1, wherein the measures relating to the interior are trays closed, head-up display activated, steering device provided, interior lighting adjusted, seat position adjusted, and/or entertainment system stopped.

10. A system for operating an automated motor vehicle during automated driving, comprising:
a scheduling unit configured to plan a motor vehicle route of the automated motor vehicle and a trajectory of the automated motor vehicle;
an environment sensor system configured to ascertain environment information relating to a motor vehicle environment of the automated motor vehicle;
a processing unit configured to determine a driving maneuver that is to be expected and an associated motoring comfort level;
an output unit configured to output advice about a change of the motoring comfort level to occupants of the automated motor vehicle; and
a device configured to automatically and actively take measures relating to the interior.

11. The system according to claim 10, wherein the processing unit is configured to ascertain acceleration values of the automated motor vehicle that are to be expected.

12. The system according to claim 10, wherein at least one of the scheduling unit and the processing unit is included in a cloud computing system.

13. The system according to claim 10, wherein the system is included in the automated motor vehicle.

14. The method according to claim 1, wherein a computer program, containing machine-readable instructions, when executed on at least one computer, is configured to cause the at least one computer to carry out the method.

15. The method according to claim 14, wherein the computer program is stored on a non-transitory machine-readable data carrier and/or download product.

16. The method according to claim 15, wherein the at least one computer includes the computer program, the non-transitory machine-readable data carrier, and/or download product.
